(19) United States
(12) Patent Application Publication
(10) Pub. No.: US 2025/0103748 A1
(43) Pub. Date: Mar. 27, 2025

(54) ELECTRONIC DEVICE THAT PRESENTS PRIVATE AND ANONYMIZED VERSIONS OF A PHOTOGRAPHIC IMAGE ON FRONT AND BACK DISPLAYS

(71) Applicant: MOTOROLA MOBILITY LLC, WILMINGTON, DE (US)

(72) Inventors: AMIT KUMAR AGRAWAL, BANGALORE (IN); BOBY IYER, ELMHURST, IL (US); BENICIO PEREIRA GOULART, CAMPINAS (BR); CARLOS PADILHA, PORTO ALEGRE/RS (BR)

(21) Appl. No.: 18/476,094

(22) Filed: Sep. 27, 2023

(51) Int. Cl. G06F 21/62; G06F 1/16; G06F 3/14; G06T 5/00; G06T 7/11; G06V 40/16

(52) U.S. Cl. CPC G06F 21/6254; G06F 1/1624; G06F 1/1641; G06F 1/1652; G06F 3/1423; G06T 5/77; G06T 7/11; G06V 40/172; G06T 2207/30196

(57) ABSTRACT

An electronic device, method and computer program product enables sharing of photographic image(s) that anonymize people contained in the photographic image(s). The electronic device includes a first housing having a first side and a second side opposite to the first side. The electronic device includes first and second displays positioned respectively on the first and second sides of the first housing. A controller of the electronic device presents, for viewing by an authorized user, photographic image(s) on the first display. In response to a trigger to concurrently present the photographic image(s) on the second display while an image display function of the electronic device is set to a privacy mode, the controller recognizes human subject(s) in the photographic image(s). The controller anonymizes the human subject(s) in a private mode version of the photographic image(s). The controller presents the private mode version of the photographic image(s) on the second display.

### BACKGROUND

### 1. Technical Field

The present disclosure relates generally to mobile handheld electronic devices, and in particular to mobile handheld electronic devices having front and back displays.

### 2. Description of the Related Art

Portable electronic communication devices, particularly smartphones, have become ubiquitous. People all over the world use such devices to stay connected. With incorporation of front and back graphical displays and cameras, mobile devices are used frequently for capturing and replaying visual content such as photographic images and video recordings. These dual display devices can also be used for sharing the photographic images with another person located on a back side of the device viewing the back display. In some situations, the owner (or an authenticated user) of the electronic device may have photographic images stored on the device and which include image content that the user would prefer to not share with others. The user has to undertake a number of manual user actions prior to the time of sharing to avoid the inadvertent sharing of these images and/or image content, while sharing other publicly sharable images and/or content.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 presents a simplified functional block diagram and three-dimensional views of a communication device presenting private and anonymized versions of a photographic image on opposed displays, according to one or more embodiments;

FIG. 2A is a front view of a first example communication device having a foldable housing assembly in an unfolded position with a front display presenting the private version of the photographic image, according to one or more embodiments;

FIG. 2B is a back view of the first example communication device of FIG. 2A having the foldable housing assembly in the unfolded position with a first back display presenting the anonymized version of the photographic image, according to one or more embodiments;

FIG. 2C is a side view of the first example communication device of FIG. 2A having the foldable housing assembly in a folded position, according to one or more embodiments;

FIG. 2D is a first back view of a first housing of the foldable housing assembly of the first example communication device of FIG. 2A having the foldable housing assembly in the folded position with the first back display presenting the private version of the photographic image, according to one or more embodiments;

FIG. 2E is a second back view of a second housing of the foldable housing assembly of the first example communication device of FIG. 2A having the foldable housing assembly in the folded position with the second back display presenting the anonymized version of the photographic image, according to one or more embodiments;

FIG. 3A is a front view of a second example communication device having an extendable blade assembly that is in a retracted position with a front portion presenting the private photographic image, according to one or more embodiments;

FIG. 3B is a left side view of the second example communication device of FIG. 3A having the extendable blade assembly in the retracted position, according to one or more embodiments;

FIG. 3C is a back view of the second example communication device of FIG. 3A having the extendable blade assembly in the retracted position with a back portion presenting the anonymized photographic image, according to one or more embodiments;

FIG. 3D is a front view of the second example communication device of FIG. 3A with the extendable blade assembly in an extended position, according to one or more embodiments;

FIG. 3E is a left side view of the second example communication device of FIG. 3A having the extendable blade assembly in the extended position, according to one or more embodiments;

FIG. 3F is a back view of the second example communication device of FIG. 3A having the extendable blade assembly in the extended position, according to one or more embodiments;

FIG. 4A is a front view of a third example communication device having an extendable housing assembly that is in a retracted position with a front portion presenting the private photographic image, according to one or more embodiments;

FIG. 4B is a left side view of the third example communication device of FIG. 4A having the extendable housing assembly in the retracted position, according to one or more embodiments;

FIG. 4C is a back view of the third example communication device of FIG. 4A having the extendable housing assembly in the retracted position with a back portion presenting the anonymized photographic image, according to one or more embodiments;

FIG. 4D is a front view of the third example communication device of FIG. 4A with the extendable housing assembly in an extended position, according to one or more embodiments;

FIG. 4E is a left side view of the third example communication device of FIG. 4A having the extendable housing assembly in the extended position, according to one or more embodiments;

FIG. 4F is a back view of the third example communication device of FIG. 4A having the extendable housing assembly in the extended position, according to one or more embodiments; and

FIGS. 5A-5D (collectively “FIG. 5”) are a flow diagram presenting a method of concurrently presenting private and anonymized versions of a photographic image on opposed displays, located on opposite sides of an electronic device, according to one or more embodiments.

### DETAILED DESCRIPTION

According to aspects of the present disclosure, an electronic device, a method, and a computer program product enables presenting or sharing of photographic image(s) that anonymize people contained in the photographic image(s), while also presenting an original version to an authorized user of the electronic device. In one or more embodiments, an electronic device includes a housing having a first side and a second side opposite to the first side. The electronic device includes a first display positioned on the first side of the housing. The electronic device includes a second display positioned on the second side of the housing. The electronic device includes a memory that stores one or more photographic images. A controller of the electronic device is communicatively coupled to the first and the second displays and to the memory. The controller presents, for viewing by an authorized user of the electronic device, the one or more photographic images on the first display. In response to a trigger to concurrently present the one or more photographic images on the second display while an image display function of the electronic device is set to a privacy mode, the controller recognizes one or more human subjects in the one or more photographic images. The controller anonymizes at least one of the one or more human subjects in a private mode version of the one or more photographic images. The controller presents the private mode version of the one or more photographic images on the second display.

When deciding to share one or more of the photographic images, a user may use photographic editing to manually select and remove people from each image, record the modified image, and transmit the modified image to intended recipient. Sharing a photographic image that maintains privacy requires a number of inconvenient user actions that may degrade a user experience in sharing their photographic images. The number of user actions may not be performed correctly, leading to a loss of privacy. Aspects of the present disclosure automate on-demand anonymizing of photographic images that are to be presented on a separate second device viewable by second user(s). The automatic anonymization provides an on-demand capability that conserves local memory resources and mitigates loss of privacy.

In the following detailed description of exemplary embodiments of the disclosure, specific exemplary embodiments in which the various aspects of the disclosure may be practiced are described in sufficient detail to enable those skilled in the art to practice the invention, and it is to be understood that other embodiments may be utilized and that logical, architectural, programmatic, mechanical, electrical, and other changes may be made without departing from the spirit or scope of the present disclosure. The following detailed description is, therefore, not to be taken in a limiting sense, and the scope of the present disclosure is defined by the appended claims and equivalents thereof. Within the descriptions of the different views of the figures, similar elements are provided similar names and reference numerals as those of the previous figure(s). The specific numerals assigned to the elements are provided solely to aid in the description and are not meant to imply any limitations (structural or functional or otherwise) on the described embodiment. It will be appreciated that for simplicity and clarity of illustration, elements illustrated in the figures have not necessarily been drawn to scale. For example, the dimensions of some of the elements are exaggerated relative to other elements.

It is understood that the use of specific component, device and/or parameter names, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that term is utilized.

As further described below, implementation of the functional features of the disclosure described herein is provided within processing devices and/or structures and can involve use of a combination of hardware, firmware, as well as several software-level constructs (e.g., program code and/or program instructions and/or pseudo-code) that execute to provide a specific utility for the device or a specific functional logic. The presented figures illustrate both hardware components and software and/or logic components.

Those of ordinary skill in the art will appreciate that the hardware components and basic configurations depicted in the figures may vary. The illustrative components are not intended to be exhaustive, but rather are representative to highlight essential components that are utilized to implement aspects of the described embodiments. For example, other devices/components may be used in addition to or in place of the hardware and/or firmware depicted. The depicted example is not meant to imply architectural or other limitations with respect to the presently described embodiments and/or the general invention. The description of the illustrative embodiments can be read in conjunction with the accompanying figures. Embodiments incorporating teachings of the present disclosure are shown and described with respect to the figures presented herein.

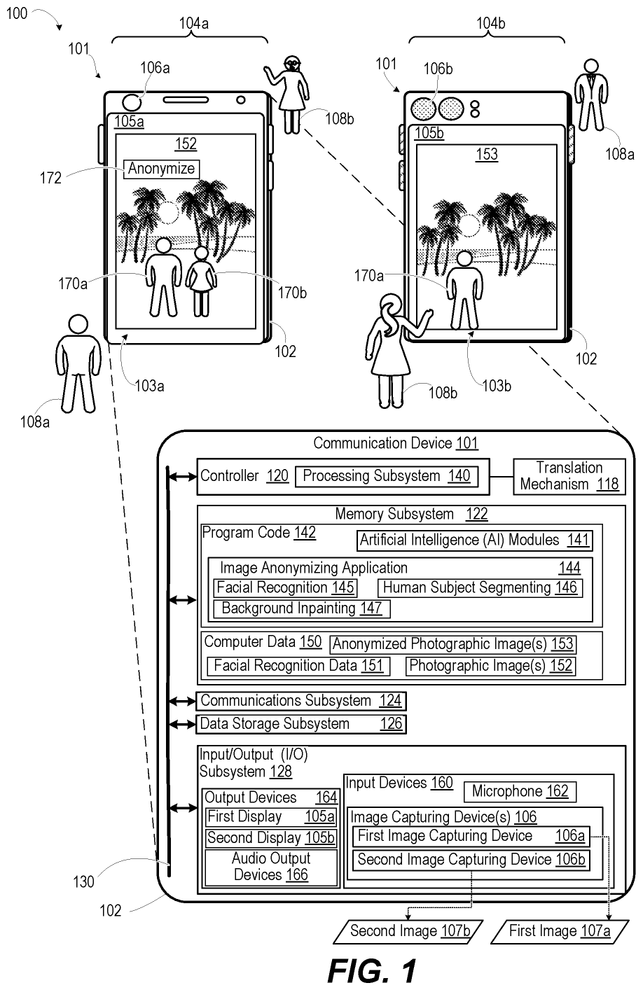

FIG. 1 presents a simplified functional block diagram of an electronic device having displays on opposite sides that may concurrently present different versions of visual content, and in which the features of the present disclosure are advantageously implemented for automatically anonymizing photographic images. In one or more embodiments, the electronic device includes additional communications functionality as communication device 101 to operate as a mobile user device in communication environment 100. Communication device 101 can be one of a host of different types of devices, including but not limited to, a mobile cellular phone, satellite phone, or smart phone, a laptop, a netbook, an ultra-book, a networked smartwatch or networked sports/exercise watch, and/or a tablet computing device or similar device that can include wireless communication functionality. As a device supporting wireless communication, communication device 101 can be utilized as, and also be referred to as, a system, device, subscriber unit, subscriber station, mobile station (MS), mobile, mobile device, remote station, remote terminal, user terminal, terminal, user agent, user device, a Session Initiation Protocol (SIP) phone, a wireless local loop (WLL) station, a personal digital assistant (PDA), computer workstation, a handheld device having wireless connection capability, a computing device, or other processing devices.

Communication device 101 includes housing 102 having first side 103a, which is depicted below left bracket 104a. First display 105a is positioned on first side 103a of housing 102. In one or more embodiments, communication device includes image capturing device(s) 106 that include first image capturing device 106a positioned on first side 103a. In an example, first image capturing device 106a produces first image 107a that may capture first person 108a who is an authorized user of communication device 101 and is viewing first display 105a. In an example, first side 103a is a front side of communication device 101.

Housing 102 has second side 103b, which is depicted below right bracket 104b. Second display 105b is positioned on second side 103b of housing 102. In one or more embodiments. image capturing device(s) 106 include second image capturing device 106b positioned on second side 103b. In an example, second image capturing device 106b produces second image 107b that may capture second person 108b who is not an authorized user of communication device 101 and is viewing second display 105b. In an example, second side 103b is a back side of communication device 101.

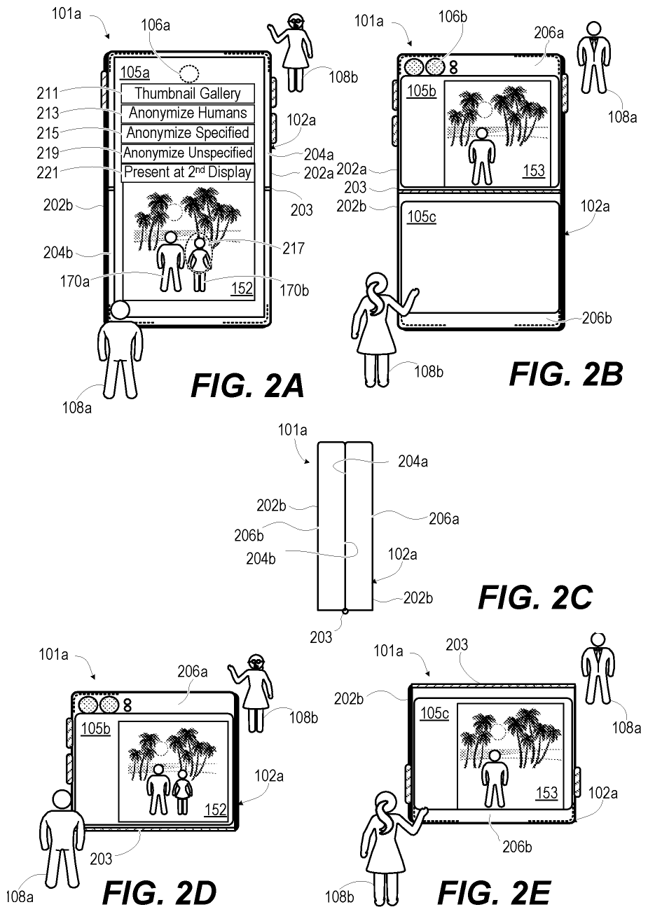

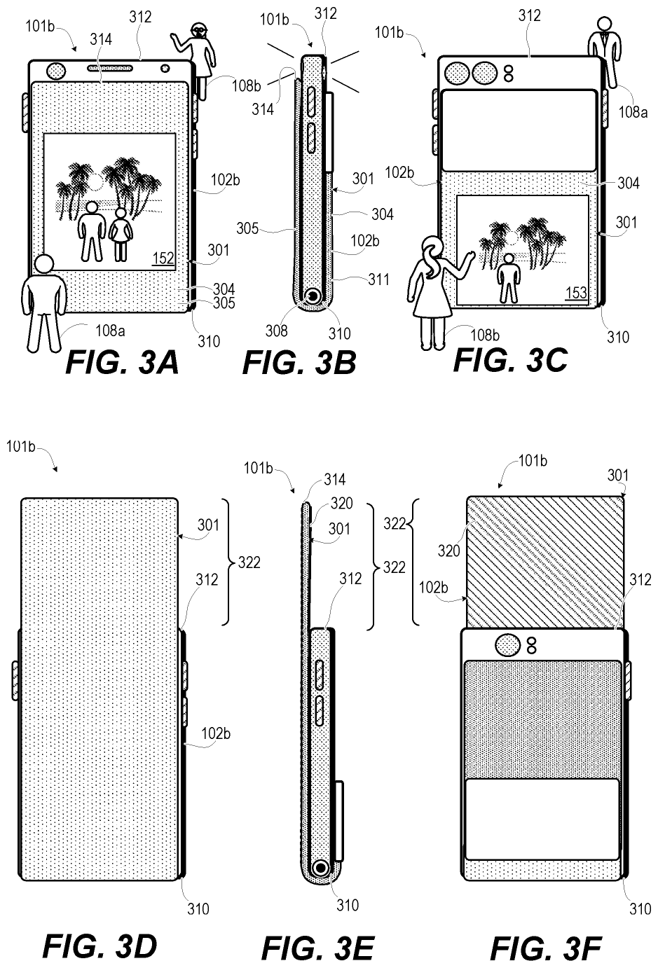

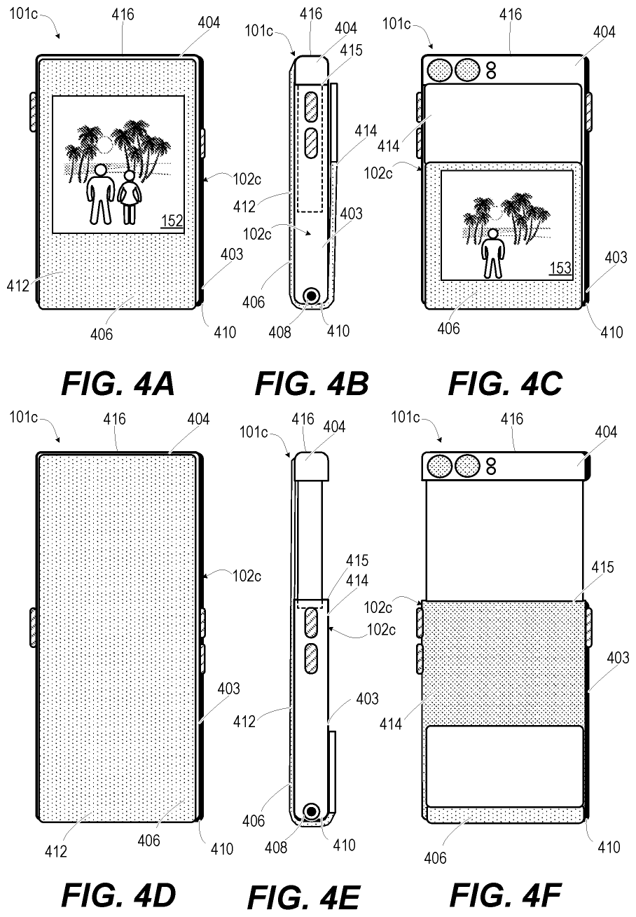

In one or more embodiments, housing 102 is implemented in a “candy bar” design form. In other embodiments described below, implementations of communication device 101 may include other design forms. First example communication device 101a of FIG. 2A has foldable housing assembly 102a. Second example communication device 101b of FIG. 3A has housing 102b that supports extendable blade assembly 301. Third example communication device 101c of FIG. 4A has extendable housing assembly 102c. Translation mechanism 118 is operable coupled to extendable blade assembly 301 (FIG. 3A) or extendable housing assembly 102c (FIG. 4A). Translation mechanism 118 can position extendable blade assembly 301 (FIG. 3A) or extendable housing assembly 102c (FIG. 4A) at any one of multiple positions between a fully retracted position, at least one intermediate position, and a fully extended position. The actual number of intermediate positions is a design feature and can be different for each device and can also be programmable, e.g., by a device user.

With continuing reference to FIG. 1, communication device 101 may include controller 120, memory subsystem 122, communications subsystem 124, data storage subsystem 126 and input/output (I/O) subsystem 128. To enable management by controller 120, system interlink 130 communicatively connects controller 120 with translation mechanism 118, memory subsystem 122, communications subsystem 124, data storage subsystem 126 and I/O subsystem 128. System interlink 130 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components. Although certain direct interconnections (i.e., system interlink 130) are illustrated in FIG. 1, it is to be understood that more, fewer, or different interconnections may be present in other embodiments.

Controller 120 includes processor subsystem 140, which includes one or more central processing units (CPUs) or data processors. Processor subsystem 140 can include one or more digital signal processors that can be integrated with data processor(s). Processor subsystem 140 can include other processors such as auxiliary processor(s) that may act as a low power consumption, always-on sensor hub for physical sensors. Controller 120 manages, and in some instances directly controls, the various functions and/or operations of communication device 101. These functions and/or operations include, but are not limited to including, application data processing, communication with second communication devices, navigation tasks, image processing, and signal processing. In one or more alternate embodiments, communication device 101 may use hardware component equivalents for application data processing and signal processing. For example, communication device 101 may use special purpose hardware, dedicated processors, general purpose computers, microprocessor-based computers, micro-controllers, optical computers, analog computers, dedicated processors and/or dedicated hard-wired logic.

Controller 120 may include various functionality that enables controller 120 to perform different aspects of artificial intelligence (AI) modules 141 for computation tasks. AI modules may include an artificial neural network, a decision tree, a support vector machine, Hidden Markov model, linear regression, logistic regression, Bayesian networks, and so forth. The AI modules can be individually trained to perform specific tasks and can be arranged in different sets of AI modules to generate different types of output.

Memory subsystem 122 stores program code 142 for execution by processor subsystem 140 to provide the functionality described herein. Program code 142 includes applications such as image anonymizing application 144 that my incorporate or utilize program code 142 such as facial recognition application 145, human subject segmenting application 146, and background inpainting application 147. Processor subsystem 140 executes anonymizing application 144 to configure communication device 101 to accept user interface inputs, supervise anonymization, and direct transmission and deletion of anonymization photographic image(s) 153. Processor subsystem 140 may execute image recognition application 145 to recognize a human shape. Processor subsystem 140 may execute image recognition application 145 to biometrically characterize a newly selected face or to identify a previously characterized face. Processor subsystem 140 executes human subject segmenting application 146 to blur or redact the shape of recognized human shape. Processor subsystem 140 executes background inpainting application 147 to replace the blurred or redacted segments with a new background image based on the surrounding background image. Image anonymizing application 144 may incorporate artificial intelligence (AI) capabilities such as AI modules 141 in being trained to recognize particular types of images. Image anonymizing application 144 may incorporate two dimensional correlations or image matching to identify a human shape.

These applications may be software or firmware that, when executed by controller 120, configures communication device 101 to provide functionality described herein. In one or more embodiments, several of the described aspects of the present disclosure are provided via executable program code of applications executed by controller 120. In one or more embodiments, program code 142 may be integrated into a distinct chipset or hardware module as firmware that operates separately from executable program code. Portions of program code 142 may be incorporated into different hardware components that operate in a distributed or collaborative manner. Memory subsystem 122 further includes operating system (OS), firmware interface, such as basic input/output system (BIOS) or Uniform Extensible Firmware Interface (UEFI), and firmware, which also includes and may thus be considered as program code 142.

Program code 142 may access, use, generate, modify, store, or communicate computer data 150, such as facial recognition data 151 obtained for example from first image 107a of first person 108a. Computer data 150 includes photographic image(s) 152 that may include human subjects considered to be private and not to be indiscriminately shared. In an example, first person 108a may be captured in photographic image(s) 152 with a third person. First person 108a may select, or image anonymizing application 144 may default to, removing all human subjects from photographic image(s) 152 to generate anonymized photographic image(s) 153 before presenting or sharing to second person 108b. First person 108a may select that only particular human subjects such as a third person should be removed from photographic image(s) 152 to generate anonymized photographic image(s) 153 before presenting or sharing to second person 108b. Computer data 150 may incorporate “data” that originated as raw, real-world “analog” information that consists of basic facts and figures. Computer data 150 includes different forms of data, such as numerical data, images, coding, notes, and financial data. Computer data 150 may originate at communication device 101 or be retrieved from a remote device via communications subsystem 124. Communication device 101 may store, modify, present, or transmit computer data 150 such as photographic images 152 and anonymized photographic images 153. Computer data 150 may be organized in one of a number of different data structures. Common examples of computer data 150 include video, graphics, text, and images. Computer data 150 can also be in other forms of flat files, databases, and other data structures.

Data storage subsystem 126 of communication device 101 includes data storage device(s). Controller 120 is communicatively connected, via system interlink 130, to data storage device(s). Data storage subsystem 126 provides program code 142 and computer data 150 stored on nonvolatile storage that is accessible by controller 120. For example, data storage subsystem 126 can provide a selection of program code 142 and computer data 150. These applications can be loaded into memory subsystem 122 for execution/processing by controller 120. In one or more embodiments, data storage device(s) can include hard disk drives (HDDs), optical disk drives, and/or solid-state drives (SSDs), etc. Data storage subsystem 126 of communication device 101 can include removable storage device(s) (RSD(s)), which is received in an RSD interface. Controller 120 is communicatively connected to the RSDs, via system interlink 130 and the RSD interface. In one or more embodiments, the RSDs are a non-transitory computer program product or computer readable storage device that may be executed by a processor associated with a user device such as communication device 101. Controller 120 can access the data storage device(s) or the RSDs to provision communication device 101 with program code 142 and computer data 150.

I/O subsystem 128 may include input devices 160 such as image capturing device(s) 106 and microphone 162. Input devices 160 may include touch input devices (e.g., screens, keys or buttons). I/O subsystem 128 may include output devices 164 such as first and second displays 105a-105b and audio output devices 166.

In one or more embodiments, controller 120, via communications subsystem 124, performs multiple types of cellular over-the-air (OTA) or wireless communication, such as by using a Bluetooth connection or other personal access network (PAN) connection. In an example, a user may wear a health monitoring device such as a smartwatch that is communicatively coupled via a wireless connection. In one or more embodiments, communications subsystem 124 includes a global positioning system (GPS) module that receives GPS broadcasts from GPS satellites to obtain geospatial location information. In one or more embodiments, controller 120, via communications subsystem 124, communicates via a wireless local area network (WLAN) link using one or more IEEE 802.11 WLAN protocols with an access point. In one or more embodiments, controller 120, via communications subsystem 124, may communicate via an OTA cellular connection with radio access networks (RANs). In an example, communication device 101, via communications subsystem 124, connects via RANs of a terrestrial network that is communicatively connected to a network server.

According to aspects of the present disclosure, controller 120 presents, for viewing by first person 108a who is an authorized user of communication device 101, photographic image(s) 152 on first display 105a. In response to a trigger to concurrently present photographic image(s) 152 on second display 105b while an image display function of communication device 101 is set to a privacy mode, controller 120 recognizes human subjects 170a-170b in photographic image(s) 152. Controller 120 anonymizes one or more human subject(s) 170a-170b in a private mode version of photographic image(s) 152 (i.e., anonymized photographic image(s) 153). Controller 120 presents anonymized photographic image(s) 153 on second display 105b. In anonymizing at least one human subject(s) 170a-170b (e.g., human subject 170b that is the third person), controller 120 may segment portion(s) of photographic image(s) 152 containing human subject(s) 170a-170b. Controller 120 redacts the portion(s) with human subject(s) to be removed/redacted. Controller 120 inpaints the area of the redacted portion(s), based on surrounding unredacted portions of photographic image(s) 152. In one or more embodiments, in order to recognize human subject(s) 170a-170b, controller 120 performs facial recognition of human subject(s) 170a-170b based on facial recognition data 151 stored in memory subsystem 122 for one or more persons (e.g., first person 108a). In one or more embodiments, to anonymize at least one of the one or more human subjects, controller 120 selectively anonymizes an identified person (e.g., human subject 170b that is the third person) designated for privacy mode, while other persons (e.g., first person 108a) not identified for privacy mode are left visible within the private mode version (i.e., anonymized photographic image(s) 153) of photographic image(s) 152.

In one or more embodiments, controller 120 captures, via first image capturing device 106a, first image 107a of first person 108a who is an authorized user of communication device 101. Controller 120 performs facial recognition of first person 108a. Controller 120 presents photographic image(s) 152 on first display 105a without anonymization in response to identifying first person 108a as an authorized user of communication device 101 based on the facial recognition.

In one or more embodiments, prior to anonymizing at least one human subject 170a-170b, controller 120 presents anonymization controls 172 on first display 105a. Examples of anonymization controls 172 is provided below with regard to FIG. 2A. With continued reference to FIG. 1, controller 120 anonymizes at least one human subjects 170a-170b in response to receiving an input to anonymization controls 172 that indicates at least one human subject 170a-170b (e.g., human subject 170b that is the third person) to anonymize from photographic image(s) 152.

FIG. 2A is a front view of first example communication device 101a that is an implementation of communication device 101 (FIG. 1) having foldable housing assembly 102a in an unfolded position. Foldable housing assembly 102a includes first housing 202a coupled at hinge 203 to second housing 202b to pivot between a fully folded position and the fully unfolded position. FIG. 2B is a back view of first example communication device 101a that is in the unfolded position. In one or more embodiments, functionality for concurrent presentation of private and anonymized photographic images is supported by communication device 101a at least in the unfolded position as depicted for FIGS. 2A-2B. In one or more embodiments, front display 105a may be a flexible display extended across both front inner sides 204a-204b respectively of first and second housings 202a-202b. One of first and second displays 105a-105b (FIG. 1) is provided by front display 105a. In an example, front display 105a presents the private version of photographic image(s) 152. At least one of first and second back outer sides 206a-206b respectively of first and second housings 202a-202b provides the other one of first and second displays 105a-105b (FIG. 1). In an example, first back display 105b on first back outer side 206a of first housing 202a presents anonymized photographic image(s) 153. Alternatively, or in addition, second back display 105c on first back outer side 206a of first housing 202a presents anonymized photographic image(s) 153.

In one or more embodiments, functionality for concurrent presentation of private and anonymized photographic images is supported by communication device 101a at least in the folded position as depicted for FIGS. 2C-2E. FIG. 2C is a side view of first example communication device 101a having foldable housing assembly 102a in a folded position. FIG. 2D is first back view of first housing 202a and first back display 105b of first example communication device 101a having foldable housing assembly 102a in the folded position. In an example, first back display 105b presents the private version of the photographic image (i.e., photographic image(s) 152). FIG. 2E is a second back view of second housing 202b and second back display 105c of first example communication device 101a having foldable housing assembly 102a in the folded position. In an example, second back display 105c presents the anonymized version of the photographic image (i.e., anonymized photographic image(s) 153).

In an example, controller 120 (FIG. 1) presents anonymization controls 172 on front display 105a that include thumbnail gallery 211 to retrieve and present compressed versions of photographic image(s) 152 stored at communication device 101a for selection. Anonymization controls 172 may include anonymize humans control 213 to select anonymizing any shape recognized as being a human shape such as by using AI modules 141 (FIG. 1). Anonymization controls 172 may include anonymize specified human subjects 215 to select anonymizing any human shape having facial biometric characteristics identified as a specific human subject to be anonymized such as by using AI modules 141 (FIG. 1). When anonymize specified human subjects 215 is selected, triggering human subject selection control 217 adds a specific human subject (e.g., second human subject 107b) to one or more human subjects indicated for anonymization. Anonymization controls 172 may include anonymize unspecified human subjects 219 to select anonymizing any human shape having facial biometric characteristics not identified as a specific human subject such as by using AI modules 141 (FIG. 1). When anonymize unspecified human subjects 219 is selected, triggering human subject selection control 217 adds a specific human subject (e.g., second human subject 170a) to one or more human subjects indicated for being presented in private mode while unspecified human subjects are anonymized. When none of the anonymization settings (213. 215 and 219) are selected. anonymization mode is deactivated. Anonymization controls 172 may include present at second display control 221 that triggers presentation of photographic image(s) 152 or anonymized photographic image(s) 153 at first or second back display 105b-105c using the currently selected anonymization mode.

FIG. 3A is a front view of second example communication device 101b having extendable blade assembly 301 in a retracted position relative to housing 102b. Flexible display 304 is attached to extendable blade assembly 301 that is aligned with front side 305 of housing 102b. FIG. 3B is a left side view of second example communication device 101b having extendable blade assembly 301 in the retracted position. Display roller 308 at first housing edge 310 of housing 102b guides extendable blade assembly 301 to roll onto back side 311 of housing 102b. First housing edge 310 is depicted as a bottom edge that is opposite second housing edge 312 of housing 102b. In the retracted position. distal edge 314 of extendable blade assembly 301 is aligned with second housing edge 312. FIG. 3C is a back view of second example communication device 101b having extendable blade assembly 301 in the retracted position. In one or more embodiments. functionality for concurrent presentation of private and anonymized photographic images is supported by communication device 101b while extendable blade assembly 301 is in the retracted position of FIGS. 3A-3C. In an example, with reference to FIG. 3A. the private version of photographic image(s) 152 is presented on front side 305. With reference to FIG. 3C. anonymized photographic image(s) 153 is presented on back side 311.

FIG. 3D is a front view of second example communication device 101b with extendable blade assembly 301 in an extended position. FIG. 3E is a left side view of second example communication device 101b having extendable blade assembly 301 in the extended position. Extendable blade assembly 301 has blade substrate 320 slidably coupled to housing 102b and capable of being moveably configured between a retracted position as depicted in FIGS. 3B and an extended position related to housing 102b as depicted in FIG. 3E. with distal edge 314 moved away from second housing edge 312 of housing 102b. Flexible display 304 is coupled to a front side of blade substrate 320 to provide the first display and the second display. Flexible display 304 moves with blade substrate 320 between the retracted position (FIG. 3B) and the extended position (FIG. 3E). Blade substrate 320 has a rigid portion that supports extended portion 322 of extendable blade assembly 301. Blade substrate 320 includes a flexible portion that contacts display roller 308 between the retracted position and the extended position to move a portion of extendable blade assembly 301 between front side 305 and back side 311. Translation mechanism 118 (FIG. 1) may be implemented as an electric motor that operates by rotating display roller 308 (FIGS. 3B and 3E) that is engaged to blade substrate 320 to slide extendable blade assembly 301 relative to housing 102b between a fully retracted position and a fully extended position. Alternatively. translation mechanism 118 (FIG. 1) may be implemented as an electric motor that operates by sliding extendable blade assembly 301 that is guided by display roller 308 that is passively positioned.

FIG. 4A is a front view of third example communication device 101c having extendable housing assembly 102c that includes base housing 403 and telescoping housing 404 in a retracted position. Flexible display 406 extends across front side 412 of base housing 403 and telescoping housing 404. FIG. 4B is a left side view of third example communication device 101c having telescoping housing 404 in the retracted position. Display roller 408 is positioned at and aligned with first housing edge 410, which is at the bottom as depicted. of base housing 403 between front side 412 and back side 414. Display roller 408 is positioned opposite both to distal edge 416 of telescoping housing 404 and second housing edge 415 of base housing 403. Flexible display 406 contacts display roller 408 between the retracted position and the extended position to move a portion of flexible display 406 between front side 412 and back side 414. FIG. 4C is a back view of third example communication device 101c having telescoping housing 404 in the retracted position. In an example, with reference to FIG. 4A. the private version of photographic image(s) 152 is presented on front side 412 of flexible display 406. With reference to FIG. 4C. anonymized photographic image(s) 153 is presented on back side 414 of flexible display 406.

FIG. 4D is a front view of third example communication device 101c with extendable housing assembly 102c in an extended position. FIG. 4E is a left side view of third example communication device 101c having extendable housing assembly 102c in the extended position. FIG. 4F is a back view of third example communication device 101c having extendable housing assembly 102c in the extended position. Translation mechanism 118 (FIG. 1) may be implemented as an electric motor that operates by rotating display roller 408 (FIGS. 4B and 4E) that is engaged to flexible display 406 to translate flexible display 406 relative to base housing 403 between a fully retracted position and a fully extended position. Alternatively. translation mechanism 118 (FIG. 1) may be implemented as an electric motor that operates by moving flexible display 406 that is guided by display roller 408 that is passively positioned.

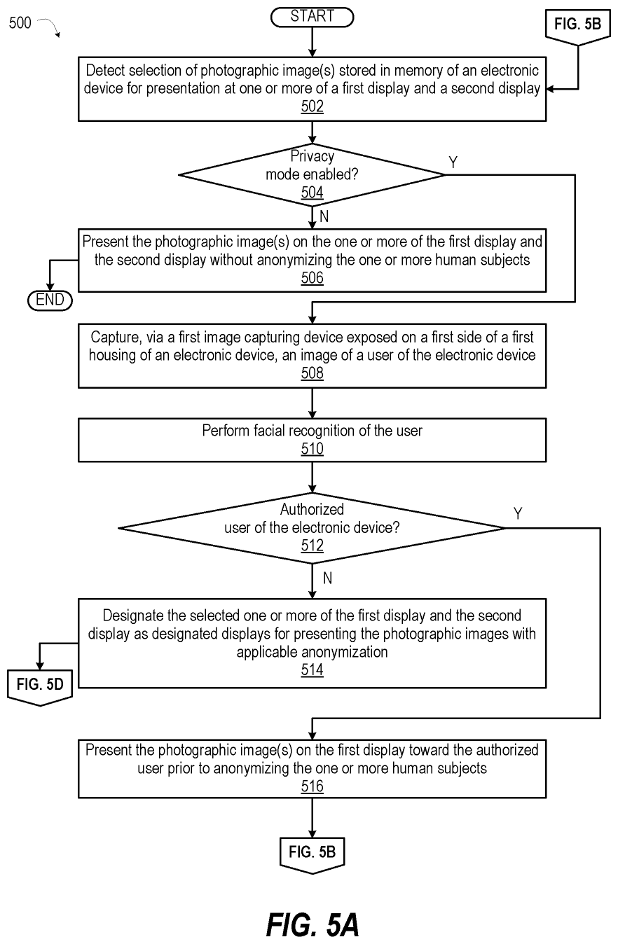

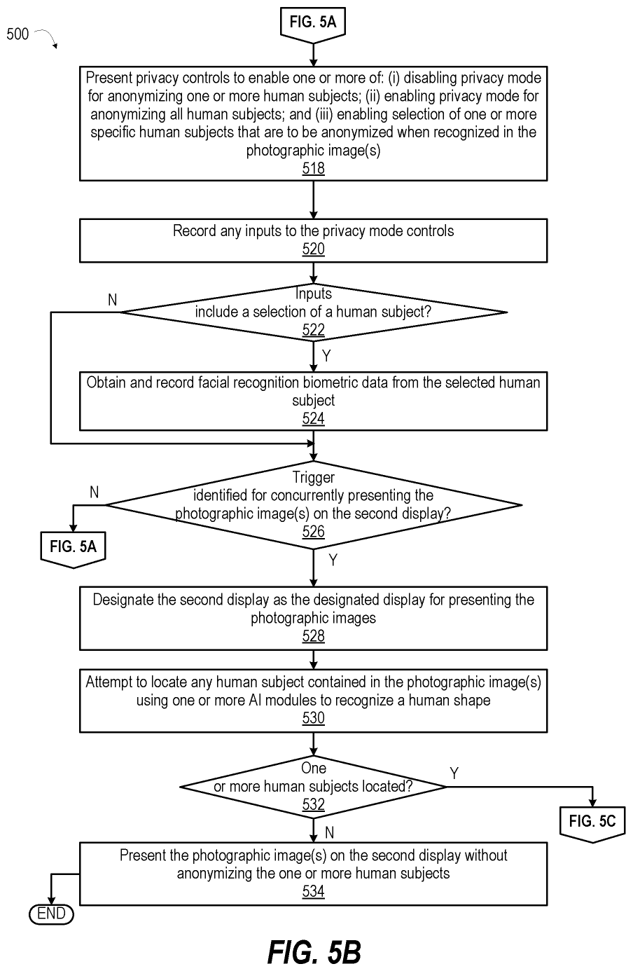

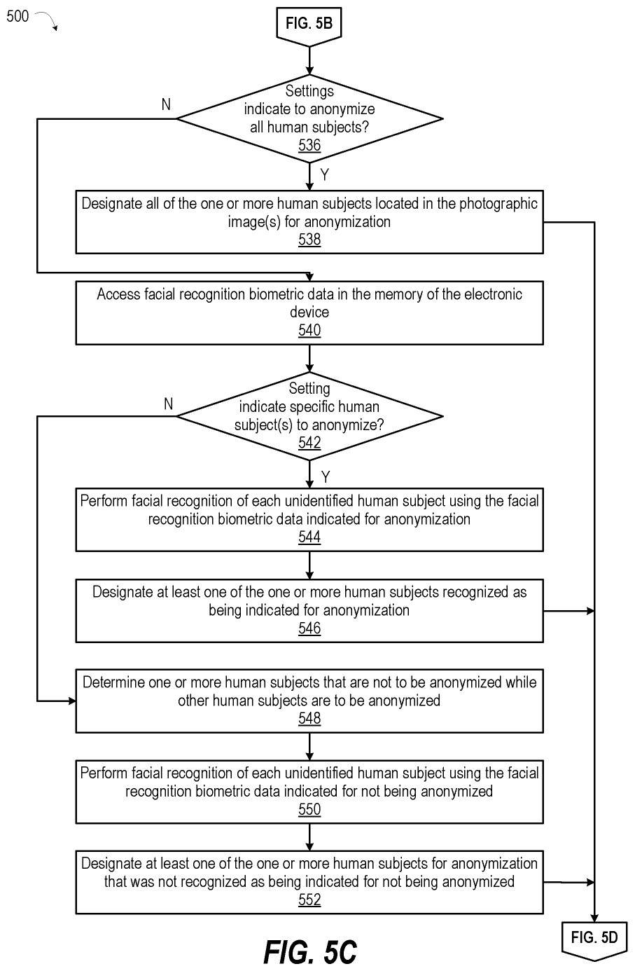

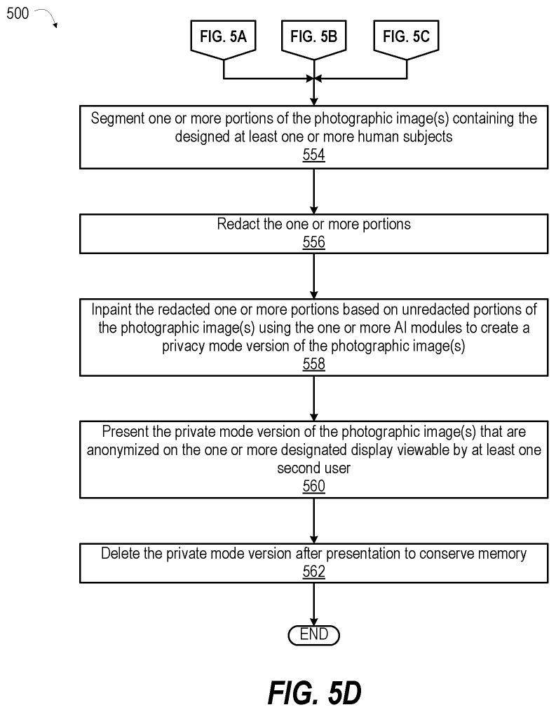

FIGS. 5A-5D (collectively “FIG. 5”) are a flow diagram presenting method 500 for presenting or sharing of photographic image(s) that anonymize people contained in the photographic image(s) while also presenting an original private version to an authorized user of the electronic device. The description of method 500 is provided with general reference to the specific components illustrated within the preceding FIGS. 1, 2A-2B, 3A-3F and 4A-4F. Specific components referenced in method 500 may be identical or similar to components of the same name used in describing preceding FIGS. 1, 2A-2B, 3A-3F and 4A-4F. In one or more embodiments, controller 120 (FIG. 1) configures communication device 101 (FIG. 1), communication device 101a (FIG. 2A), communication device 101b (FIG. 3A), communication device 101c (FIG. 4A) or a similar computing device to provide the described functionality of method 500.

With reference to FIG. 5A, in one or more embodiments, method 500 includes detecting selection of photographic image(s) stored in memory of an electronic device for presentation at one or more of a first display and a second display (block 502). Method 500 includes determining whether privacy mode is enabled (decision block 504). In response to determining that privacy mode is not enabled (i.e., is disabled), method 500 includes presenting the one or more photographic images on the first display without anonymizing the one or more human subjects (block 506). Then method 500 ends. Method 500 includes capturing, via a first image capturing device exposed on a first side of a first housing of an electronic device, an image of a user of the electronic device (block 508). Method 500 includes performing facial recognition of the user (block 510). Method 500 includes determining whether the user is recognized as an authorized user of the electronic device (decision block 512). In response to determining that the user is not an authorized user, method 500 includes designating the selected one or more of the first display and the second display as designated displays for presenting the photographic images with applicable anonymization (block 514). Then method 500 proceeds to block 554 (FIG. 5D). In response to determining that the user is an authorized user, method 500 includes presenting the one or more photographic images on the first display toward the authorized user prior to anonymizing the one or more human subjects (block 516). Then method 500 proceeds to block 518 (FIG. 5B).

With reference to FIG. 5B, in one or more embodiments, method 500 includes presenting privacy controls on a display of the device to enable one or more of: (i) disabling privacy mode for anonymizing one or more human subjects; (ii) enabling privacy mode for anonymizing all human subjects; and (iii) enabling selection of one or more specific human subjects that are to be anonymized when recognized in the one or more photographic images (block 518). In one or more embodiments, the presentation of the privacy controls can occur as a camera, gallery, or device setting features that does not require the specific image be presented at the time of the user setting. Thus, for example, the user can enter the camera or gallery settings on the communication device and select, within an image sharing privacy settings (ISPS) user interface, specific persons to make private and/or to anonymize when sharing or presenting photographic images. The camera and/or gallery ISPS UI can include additional settings to support other features, such as entry of a list of authorized users who have permission to view the private image, toggling the device's image sharing privacy mode on or off, etc.

Returning to FIG. 5B, method 500 includes recording any inputs to the privacy mode controls (block 520). Method 500 includes determining whether the inputs to the privacy mode controls include a selection of a human subject in the one or more photographic images (decision block 522). In response to determining that the inputs to the privacy controls include a selection of a human subject in the one or more photographic images, method 500 includes obtaining and recording facial recognition biometric data from the selected human subject (block 524). In response to determining that the inputs to the privacy mode controls do not include a selection of a human subject in the one or more photographic images in decision block 522 or after block 524, method 500 includes determining whether a trigger is identified for concurrently presenting the one or more photographic images on the second display (decision block 526). In response to determining that the trigger is not identified for presenting the one or more photographic images on a second display, method 500 returns to block 502 (FIG. 5A). In response to determining that the trigger is identified for presenting the one or more photographic images concurrently on a second display, method 500 includes designating the second display as the designated display for presenting the photographic images (block 528). Method 500 includes attempting to locate any human subject contained in the photographic image(s) using one or more AI modules to recognize a human shape (block 530). The AI modules may include an artificial neural network, a decision tree, a support vector machine, Hidden Markov model, linear regression, logistic regression, Bayesian networks, and so forth. The AI modules can be individually trained to perform specific tasks and can be arranged in different sets of AI modules to generate different types of output. Method 500 includes determining whether one or more human subjected are located (decision block 532). In response to determining that one or more human subjected are not located,
method 500 includes presenting the one or more photographic images on the second display without anonymizing the one or more human subjects (block 534). Then method 500 ends. In response to determining that one or more human subjected are located, method 500 proceeds to block 536 (FIG. 5C).

With reference to FIG. 5C, method 500 includes determining whether settings indicate to anonymize all human subjects (decision block 536). In response to determining that settings indicate to anonymize all human subjects, method 500 includes designating all of the one or more human subjects located in the photographic image(s) for anonymization (block 538). Then method 500 proceeds to block 554 (FIG. 5D). In response to determining that settings do not indicate to anonymize all human subjects, method 500 includes accessing facial recognition biometric data in the memory of the electronic device (block 540). Method 500 includes determining whether the settings indicate specific one or more human subjects to anonymize (decision block 542). In response to determining that the settings indicate specific one or more human subjects to anonymize, method 500 includes performing facial recognition of each unidentified human subject using the facial recognition biometric data indicated for anonymization (block 544). Method 500 includes designating at least one of the one or more human subjects recognized as being indicated for anonymization (block 546). Then method 500 proceeds to block 554 (FIG. 5D). In response to determining that the settings do not indicate specific one or more human subjects to anonymize, method 500 includes determining one or more human subjects that are not to be anonymized while other human subjects are to be anonymized (block 548). Method 500 includes performing facial recognition of each unidentified human subject using the facial recognition biometric data indicated for not being anonymized (block 550). Method 500 includes designating at least one of the one or more human subjects for anonymization that was not recognized as being indicated for not being anonymized (block 552). Then method 500 proceeds to block 554 (FIG. 5D).

With reference to FIG. 5D, method 500 includes segmenting one or more portions of the one or more photographic images containing the one or more human subjects (block 554). Method 500 includes redacting the one or more portions corresponding to the human subjects to be anonymized (block 556). Method 500 includes inpainting the redacted one or more portions based on unredacted surrounding portions of the one or more photographic images using the one or more AI modules to create a privacy mode version of the one or more photographic images (block 558). In one or more embodiments, the AI modules support “magic eraser” functionality that can locate, identify, and remove at least one human subject with an AI-generated replacement background to camouflage the removed human subject(s). Method 500 includes presenting the private mode version of the one or more photographic images that are anonymized on the designated display viewable by at least one second user (block 560). Method 500 includes deleting the private mode version after presentation is concluded to conserve memory (block 562). Then method 500 ends.

In one or more embodiments, the electronic device includes a second housing that is coupled at a hinge to the first housing to form a foldable housing assembly that pivots between a fully folded position and a fully unfolded position. Method 500 may further include presenting the one or more photographic images on the first display that is positioned on one of: (i) a front side of the housing assembly exposed only in an unfolded position; or (ii) a back side of the housing assembly exposed in both the fully folded and unfolded positions. Method 500 may further include presenting the private mode version of the one or more photographic images on the second display that is positioned on the other one of the front side and the back side.

In one or more embodiments, method 500 may further include activating a translation mechanism to retract a blade of a blade assembly prior to presenting the private mode version of the one or more photographic images on the second display. The blade is slidably coupled to the first housing and capable of being moveably configured between a retracted position and an extended position related to the first housing. Method 500 may further include presenting the one or more photographic images and the private mode version via a flexible display coupled to a front side of the blade to provide one of the first display and the second display. The flexible display moves with the blade between the retracted position and the extended position. A portion of the flexible display rolls onto a back side of the first housing while in the retracted position to provide the other one of the first display and the second display.

In one or more embodiments, prior to presenting the private mode version of the one or more photographic images on the second display, method 500 may further include activating a translation mechanism to retract a telescoping housing having an extension portion slidingly received into the first housing while the telescoping housing is in a retracted position. Method 500 may further include presenting the one or more photographic images and the private mode version via a flexible display coupled to a front side of the telescoping housing and the first housing to provide one of the first display and the second display. A remaining portion of the flexible display rolls around the first housing onto a back side of the first housing while the telescoping housing is in the retracted position to provide the other one of the first display and the second display.

Aspects of the present innovation are described above with reference to flowchart illustrations and/or block diagrams of methods, apparatus (systems) and computer program products according to embodiments of the innovation. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

As will be appreciated by one skilled in the art, embodiments of the present innovation may be embodied as a system, device, and/or method. Accordingly, embodiments of the present innovation may take the form of an entirely hardware embodiment or an embodiment combining software and hardware embodiments that may all generally be referred to herein as a “circuit,” “module” or “system.”

While the innovation has been described with reference to exemplary embodiments, it will be understood by those skilled in the art that various changes may be made, and equivalents may be substituted for elements thereof without departing from the scope of the innovation. In addition, many modifications may be made to adapt a particular system, device, or component thereof to the teachings of the innovation without departing from the essential scope thereof. Therefore, it is intended that the innovation not be limited to the particular embodiments disclosed for carrying out this innovation, but that the innovation will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the innovation. As used herein, the singular forms “a”, “an” and “the” are intended to include the plural forms as well, unless the context clearly indicates otherwise. It will be further understood that the terms “comprise” and/or “comprising.” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present innovation has been presented for purposes of illustration and description but is not intended to be exhaustive or limited to the innovation in the form disclosed. Many modifications and variations will be apparent to those of ordinary skill in the art without departing from the scope and spirit of the innovation. The embodiments were chosen and described in order to best explain the principles of the innovation and the practical application, and to enable others of ordinary skill in the art to understand the innovation for various embodiments with various modifications as are suited to the particular use contemplated.

What is claimed is:

1. An electronic device comprising:
a housing having a first side and a second side opposite to the first side;
a first display positioned on the first side of the housing;
a second display positioned on the second side of the housing;
a memory that stores one or more photographic images; and
a controller communicatively coupled to the first and the second displays and to the memory, and which:
presents, for viewing by an authorized user of the electronic device, the one or more photographic images on the first display; and
in response to a trigger to concurrently present the one or more photographic images on the second display while an image display function of the electronic device is set to a privacy mode:
recognizes one or more human subjects in the one or more photographic images;
anonymizes at least one of the one or more human subjects in a private mode version of the one or more photographic images; and
presents the private mode version of the one or more photographic images on the second display.

2. The electronic device of claim 1, wherein, in anonymizing the at least one of the one or more human subjects, the controller:
segments one or more portions of the one or more photographic images containing the one or more human subjects;
redacts the one or more portions; and
inpaints the redacted one or more portions based on unredacted portions of the one or more photographic images.

3. The electronic device of claim 1, wherein:
in recognizing the one or more human subjects, the controller performs facial recognition of the one or more human subjects based on facial recognition data stored in the memory for one or more persons; and
to anonymize the at least one of the one or more human subjects, the controller selectively anonymizes an identified person designated for privacy mode, while other persons not identified for privacy mode are left visible within the private mode version of the one or more photographic images.

4. The electronic device of claim 1, further comprising at least one image capturing device communicatively coupled to the controller and comprising a first image capturing device exposed on the first side of the housing, and wherein the controller:
captures, via the first image capturing device, an image of a user of the electronic device;
performs facial recognition of the user; and
presents the one or more photographic images on the first display without anonymization in response to identifying the authorized user of the electronic device based on the facial recognition.

5. The electronic device of claim 1, wherein the controller, prior to anonymizing the at least one of the one or more human subjects:
presents anonymization controls on the first display; and
anonymizes the at least one of the one or more human subjects in response to receiving an input to the anonymization controls that indicates the at least one of the one or more human subjects to anonymize from the one or more photographic images.

6. The electronic device of claim 1, wherein the housing is a foldable housing assembly comprising a first housing coupled at a hinge to a second housing that pivots between a fully folded position and a fully unfolded position;
the first display is positioned on one of: (i) a front side of the foldable housing assembly exposed only in an unfolded position; or (ii) a back side of the foldable housing assembly exposed in both the fully folded and unfolded positions; and
the second display is positioned on the other one of the front side and the back side.

7. The electronic device of claim 1, further comprising:
a blade assembly having a blade slidably coupled to the housing and capable of being moveably configured between a retracted position and an extended position related to the housing;
a flexible display coupled to a front side of the blade to provide one of the first display and the second display, the flexible display moving with the blade between the retracted position and the extended position, a portion of the flexible display rolling onto a back side of the housing while in the retracted position to provide the other one of the first display and the second display; and
a translation mechanism communicatively coupled to the controller and operably engaged to the blade to position the blade assembly, and wherein the controller activates the translation mechanism to retract the blade assembly prior to presenting the private mode version of the one or more photographic images on the second display.

8. The electronic device of claim 1, wherein the housing comprises a base housing and a telescoping housing having an extension portion slidingly received into the base housing while the telescoping housing is in a retracted position, the electronic device further comprising:
a flexible display coupled to a front side of the telescoping housing and the base housing to provide one of the first display and the second display, a remaining portion of the flexible display rolling around the base housing onto a back side of the base housing while the telescoping housing is in the retracted position to provide the other one of the first display and the second display; and
a translation mechanism communicatively coupled to the controller and operably engaged to the telescoping housing to position the telescoping housing relative to the base housing, and wherein the controller activates the translation mechanism to retract the telescoping housing prior to presenting the private mode version of the one or more photographic images on the second display.

9. A method comprising:
retrieving one or more photographic images stored in a memory of an electronic device having a housing with a first side and a second side opposite to the first side;
presenting, for viewing by an authorized user of the electronic device, the one or more photographic images on a first display on the first side of the housing; and
in response to a trigger to concurrently present the one or more photographic images on a second display positioned on the second side of the housing while an image display function of the electronic device is set to a privacy mode:
recognizing one or more human subjects in the one or more photographic images;
anonymizing at least one of the one or more human subjects in a private mode version of the one or more photographic images; and
presenting the private mode version of the one or more photographic images on the second display.

10. The method of claim 9, wherein anonymizing the at least one of the one or more human subjects comprises:
segmenting one or more portions of the one or more photographic images containing the one or more human subjects;
redacting the one or more portions; and
inpainting the redacted one or more portions based on unredacted portions of the one or more photographic images.

11. The method of claim 9, wherein:
recognizing the one or more human subjects comprises performing facial recognition of the one or more human subjects based on facial recognition data stored in the memory for one or more persons; and
anonymizing the at least one of the one or more human subjects comprises selectively anonymizing an identified person designated for privacy mode, while other persons not identified for privacy mode are left visible within the private mode version of the one or more photographic images.

12. The method of claim 9, further comprising:
capturing, via a first image capturing device exposed on the first side of the housing, an image of a user of the electronic device;
performing facial recognition of the user; and
presenting the one or more photographic images on the first display without anonymization in response to identifying the authorized user of the electronic device based on the facial recognition.

13. The method of claim 9, further comprising:
prior to anonymizing the at least one of the one or more human subjects:
presenting anonymization controls on the first display; and
anonymizing the at least one of the one or more human subjects in response to receiving an input to the anonymization controls that indicates the at least one of the one or more human subjects to anonymize from the one or more photographic images.

14. The method of claim 9, wherein the housing comprises a foldable housing assembly having a first housing is coupled at a hinge to a second housing that pivots between a fully folded position and a fully unfolded position, and wherein the method further comprises:
presenting the one or more photographic images on the first display that is positioned on one of: (i) a front side of the foldable housing assembly exposed only in an unfolded position; or (ii) a back side of the foldable housing assembly exposed in both the fully folded and unfolded positions; and
presenting the private mode version of the one or more photographic images on the second display that is positioned on the other one of the front side and the back side and that is currently exposed in either the folded or unfolded position.

15. The method of claim 9, further comprising:
activating a translation mechanism to retract a blade of a blade assembly prior to presenting the private mode version of the one or more photographic images on the second display, the blade slidably coupled to the housing and capable of being moveably configured between a retracted position and an extended position related to the housing; and
presenting the one or more photographic images and the private mode version via a flexible display coupled to a front side of the blade to provide one of the first display and the second display, the flexible display moving with the blade between the retracted position and the extended position, a portion of the flexible display rolling onto a back side of the housing while in the retracted position to provide the other one of the first display and the second display.

16. The method of claim 9, wherein the housing comprises a base housing and a telescoping housing, the method further comprising:
prior to presenting the private mode version of the one or more photographic images on the second display, activating a translation mechanism to retract the telescoping housing having an extension portion slidingly received into the base housing while the telescoping housing is in a retracted position; and
presenting the one or more photographic images and the private mode version via a flexible display coupled to a front side of the telescoping housing and the base housing to provide one of the first display and the second display, a remaining portion of the flexible display rolling around the base housing onto a back side of the base housing while the telescoping housing is in the retracted position to provide the other one of the first display and the second display.

17. A computer program product comprising:
a computer readable storage device; and
program code on the computer readable storage device that when executed by a processor associated with an electronic device, the program code enables the electronic device to provide functionality of:
retrieving one or more photographic images stored in a memory of an electronic device having a housing with a first side and a second side opposite to the first side;
presenting, for viewing by an authorized user of the electronic device, the one or more photographic images on a first display on the first side of the housing; and
in response to a trigger to concurrently present the one or more photographic images on a second display positioned on the second side of the housing while an image display function of the electronic device is set to a privacy mode:
recognizing one or more human subjects in the one or more photographic images;
anonymizing at least one of the one or more human subjects in a private mode version of the one or more photographic images; and
presenting the private mode version of the one or more photographic images on the second display.

18. The computer program product of claim 17, wherein the program code enables the electronic device to provide functionality of:
segmenting one or more portions of the one or more photographic images containing the at least one of the one or more human subjects;
redacting the one or more portions; and
inpainting the redacted one or more portions based on unredacted portions of the one or more photographic images.

19. The computer program product of claim 17, wherein the program code enables the electronic device to provide functionality of:
recognizing the one or more human subjects comprises performing facial recognition of the one or more human subjects based on facial recognition data stored in the memory for one or more persons; and
anonymizing the at least one of the one or more human subjects comprises selectively anonymizing an identified person designated for privacy mode, while other persons not identified for privacy mode are left visible within the private mode version of the one or more photographic images.

20. The computer program product of claim 17, wherein the program code enables the electronic device to provide functionality of:
capturing, via a first image capturing device exposed on the first side of the housing, an image of a user of the electronic device;
performing facial recognition of the user; and
presenting the one or more photographic images on the first display without anonymization in response to identifying the authorized user of the electronic device based on the facial recognition.
